(19) United States
(12) Patent Application Publication
(10) Pub. No.: US 2025/0232747 A1
(43) Pub. Date: Jul. 17, 2025

(54) THREE-DIMENSIONAL GUITAR CONNECTION JOINT BETWEEN A NECK TO A GUITAR BODY

(71) Applicant: EASTMAN MUSIC COMPANY, Pomona, CA (US)

(72) Inventor: Mathew Otto D'Ambrosio, Upland, CA (US)

(73) Assignee: EASTMAN MUSIC COMPANY, Pomona, CA (US)

(21) Appl. No.: 19/018,379

(22) Filed: Jan. 13, 2025

Related U.S. Application Data
(60) Provisional application No. 63/621,865, filed on Jan. 17, 2024.

(51) Int. Cl. G10D 3/06

(52) U.S. Cl. CPC G10D 3/06

(57) ABSTRACT

Described is a three-dimensional guitar connection joint between a neck and guitar body. The joint includes a guitar body and neck. The body has a shaped neck receptor for receiving a guitar neck, while the neck includes a stepped connector and an elongated portion extending from the stepped connector to a distal end. The stepped connector is formed to nest within the shaped neck receptor. A bracket and bolts secure the neck into the neck receptor, while the neck and body are shaped to collectively form a pocket for a guitar pickup.

### CROSS-REFERENCE TO RELATED APPLICATIONS

This is a non-provisional application of U.S. Provisional Application No. 63/621,865, filed Jan. 17, 2024, the entirety of which is incorporate herein by reference.

### BACKGROUND OF THE INVENTION

### (1) Field of Invention

The present invention relates to guitar neck and body connectors and, more particularly, to a three-dimensional connection joint for connecting a neck of a bolt-on guitar to the guitar body.

### (2) Description of Related Art

Guitars are typically comprised of a body having a neck extending therefrom. The strings of the guitar are generally connected with the body and then pass along the length of the neck. Importantly, the neck is almost always formed as a separate piece of wood that is adhered or otherwise bolted onto the body. Existing prior art techniques use a large plate and four bolts or screws that pass through the body and into the neck. Notably, in this aspect, the neck barely goes into the body and is merely bolted to the exterior of the body. Further, while generally secure, the use of the additional metallic hardware creates stress points within the wood and, importantly, affects the tonal resonance of the guitar. Further, the connection technique in the prior art limits tuning stability while also being prone to neck shift caused by humidity fluctuations or rough use.

Thus, a continuing need exists for a new and improved connection joint between the guitar neck and body that provides superior tuning stability, better tonal resonance and resilience against neck shift.

### SUMMARY OF INVENTION

The present invention relates to guitar neck and body connectors and, more particularly, to a three-dimensional connection joint for connecting a neck of a bolt-on guitar to the guitar body and the guitar resulting therefrom.

In one aspect, the three-dimensional guitar connection joint includes a guitar body having a shaped neck receptor for receiving a guitar neck; and a guitar neck having a first end with a stepped connector and an elongated portion extending from the stepped connector to a distal end, the stepped connector being formed to nest within the shaped neck receptor.

In another aspect, the elongated portion has a bottom surface, with the stepped connector projecting below the bottom surface.

In another aspect, a neck passage is formed in the body adjacent to the shaped neck receptor that passes from the neck receptor to an exterior of the body, the neck passage formed to receive the elongated portion of the guitar neck.

Additionally, the stepped connected includes a step shaped aperture.

Further, the body includes a pair of voids of that are adjacent to and straddle opposing sides of the neck receptor. The pair of voids and step shaped aperture collectively form a pocket across the top of the neck to allow for placement of a guitar pickup.

In another aspect, a fastener setup secures the neck into neck receptor. The fastener setup includes a bracket positioned on a bottom-side of the body and two anchors embedded into the neck, with fasteners passing through the bracket and being secured into the two anchors to secure the neck to the body.

In yet another aspect, a guitar pickup is positioned in the pocket.

Finally, as can be appreciated by one in the art, the present invention also comprises a method for forming and using the invention described herein, as well as the resulting guitar the includes the described connection joint.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1A is an exploded-view illustration of a guitar body and neck according to various aspects of the present invention, depicting the guitar body being formed with a shaped neck receptor for receiving and connecting with the neck to collectively form the connection joint;

FIG. 1B is a close-up detail view as taken from FIG. 1A;

FIG. 2A is a side-view illustration of the neck;

FIG. 2B is a side-view illustration of the body;

FIG. 3 is an illustration of the neck as affixed with the guitar body;

FIG. 4A is a front-view illustration of a guitar body with attached neck;

FIG. 4B is a cross-sectional, side-view illustration of the neck, taken from line A-A of FIG. 4A;

FIG. 4C is a cross-sectional, side-view illustration of the body, taken from line A-A of FIG. 4A;

FIG. 5 is a back-view illustration of the guitar body, depicting placement of a bracket for passage of the bolts to affix the neck to the body;

FIG. 6A is a top-view illustration of an example tee nut for affixing within the neck to allow for a bolt to pass through the body to secure the neck against the body;

FIG. 6B is a side-view illustration of the tee nut depicted in FIG. 6A;

FIG. 7 is an illustration of another aspect, in which the body is double cut; and

FIG. 8 is an illustration of another aspect, in which the body is single cut.

### DETAILED DESCRIPTION

The present invention is directed to a three-dimensional guitar connection joint for connecting a neck of a bolt-on guitar to the guitar body. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### (1) Description

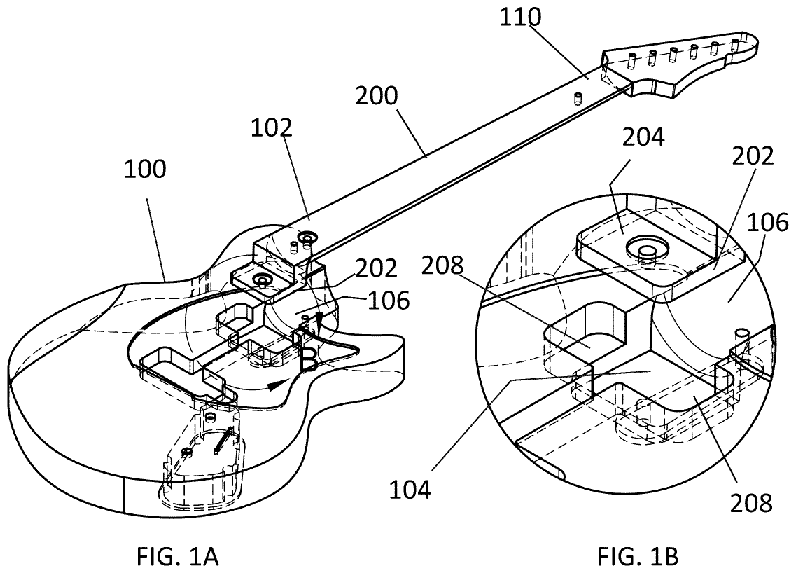

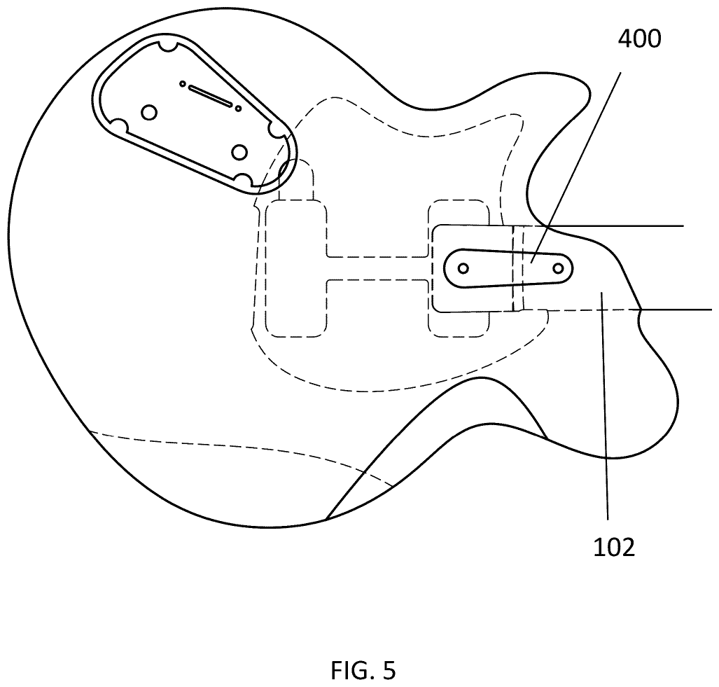

As shown in FIGS. 1 through 8, the present disclosure is directed to a three-dimensional guitar connection joint between a guitar body 100 and neck 102. The connection joint includes the guitar body 100, neck 102, and all other components as described herein. The guitar body 100 and neck 102 are each formed of any suitable material known to those skilled in the art, non-limiting examples of which include wood, plastic, and fiberglass. Notably, the neck 102 and guitar body 100 are both shaped to allow the neck 102 to nest within a shaped neck receptor 104 that is formed within the guitar body 100. The shaped neck and neck receptor 104 utilize a three-dimensional geometry (i.e., stepped mortise and tenon) to mechanically secure the neck 102 into the guitar body 100 using any suitable fastener setup. In one aspect, the neck 102 has an elongated portion 200 and a stepped connector 202 that rests below a bottom surface 206 of the elongated portion 200. In other words, the stepped connector 202 projects downward below the adjacent bottom surface 206 of the elongated portion 200. The stepped connector 202 is formed to nest within the neck receptor 104 and is supported at least partially on all sides by the shaped neck receptor 104, thereby preventing any rotation therein. Further and as illustrated in FIGS. 1A and 1B, a neck passage 106 is formed in the body 100 adjacent to the shaped neck receptor 104 that passes from the neck receptor 104 to the exterior of the body 100. The neck passage 106 is formed to similarly allow for nesting of the neck 102 as it passes away from the stepped connector 202 to the distal end 110 of the neck 102.

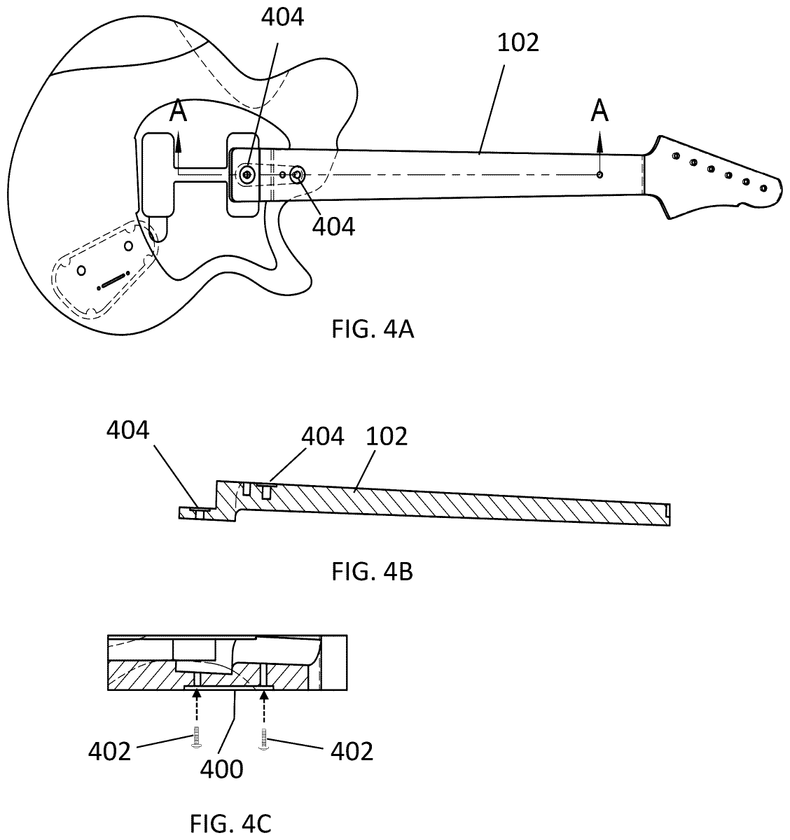

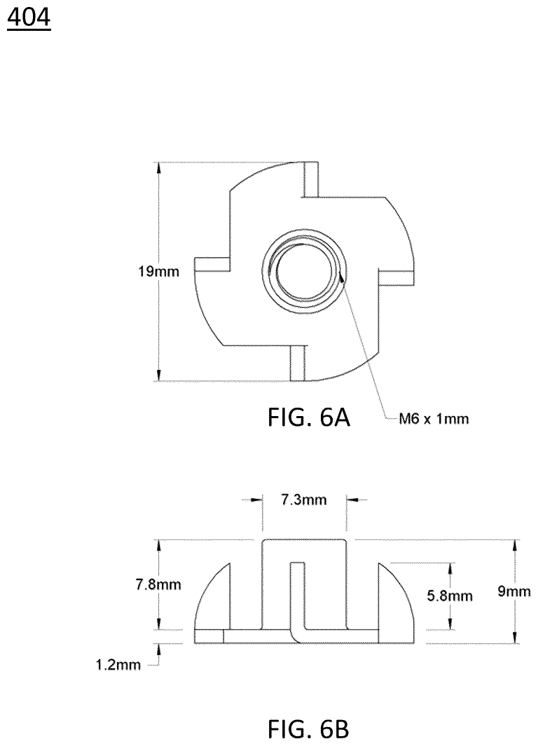

Due to the nesting configuration, the connection joint of the present invention can be secured using a fastener setup that minimizes the amount of metal and other components. Any suitable fastener setup can be utilized to secure the neck 102 to the body 100. As a non-limiting example and as shown in FIG. 4A through FIG. 6B, the fastener setup includes a bracket 400 (e.g., steel bracket, etc), fasteners (e.g., two machine screws or bolts 402), and anchors (e.g., two tee-nut anchors 404) embedded into the neck 102. Desirably, the bracket 400 can be positioned or otherwise affixed to a bottom-side of the body to allow the fasteners (e.g., bolts 402) to pass therethrough and into the nut anchors 404. It should be noted that although dimensions are provided in FIGS. 6A and 6B as one example embodiment, the invention is not intended to be limited thereto as alternative sizes and shapes can be utilized as understood by those skilled in the art.

Once the two pieces (i.e., the neck 102 and body) are attached, the stepped mortise and tenon (i.e., stepped connector 202 nested within the shaped neck receptor 104 in conjunction with the neck 102 resting within the neck passage 106) prevent the neck 102 from moving or shifting in any direction. With the neck 102 in the present invention, the construction makes the neck 102 go deeper into the body 100 than the prior art while also minimizing the amount of hardware used. This results in more tone in the guitar, more sustainability, more strength, and more stability and can be securely held in place with as little as two connectors (e.g., screws or bolts 402). This provides a number of functional attributes for the musician, including but not limited to a superior tuning stability, as well as better tonal resonance and resilience against neck shift caused by humidity fluctuations or rough use.

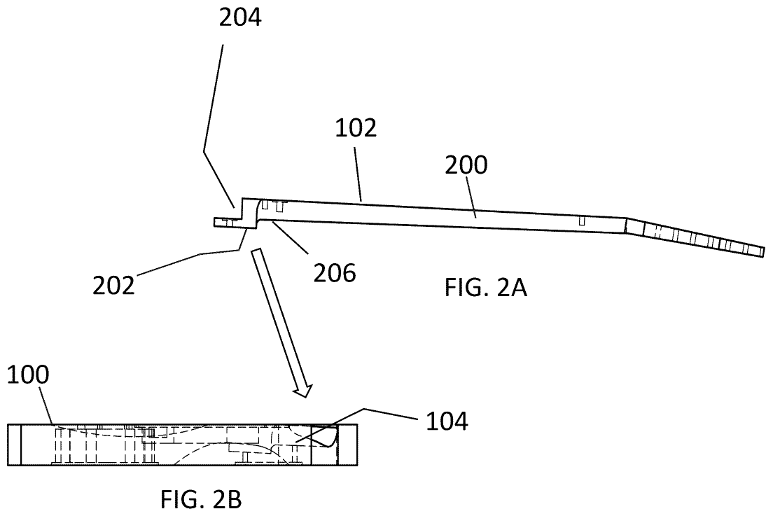

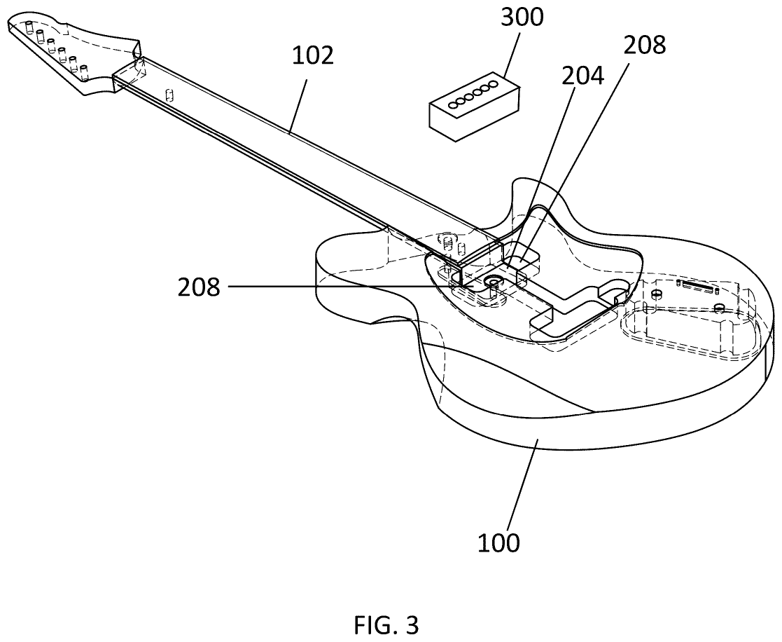

As shown in the side-view illustration of FIG. 2A, in one aspect, the shaping of the stepped connector 202 creates a step shaped aperture 204 in the neck 102 that is formed to accommodate and secure a guitar pickup. Further and referring to FIG. 1B, the body 100 is formed to include a pair of voids 208 that are adjacent to and straddle opposing sides of the neck receptor 104. As illustrated in FIG. 3, once the neck 102 is affixed into the body, the voids 208 and step shaped aperture 204 collectively form a pocket across the top of the neck 102 to allow for placement of the guitar pickup 300. As can be appreciated by those skilled in the art, the body 100 can be formed to allow for multiple different pickup configurations. In one aspect, the pickup pocket is oversized so that different sizes of pickups can be used in one body style.

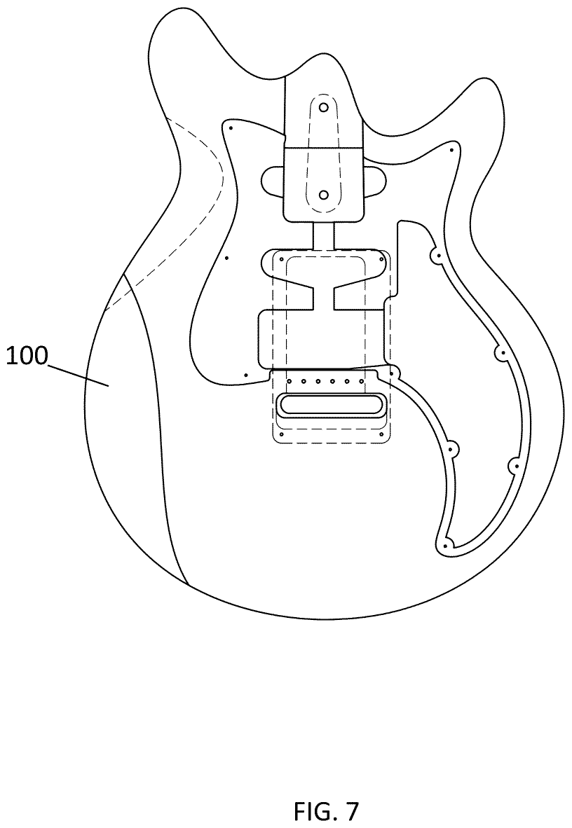

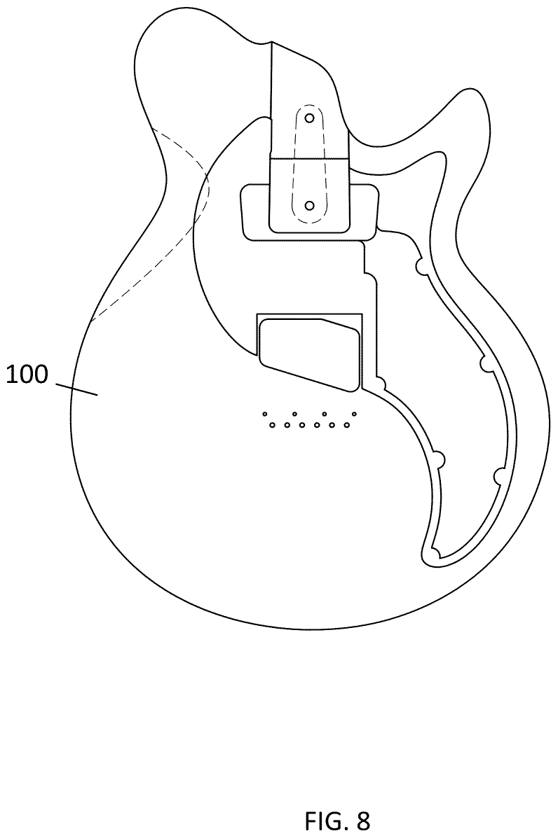

It should be noted that the guitar connection joint can be implemented in many body shapes. For example, FIG. 7 is an illustration of another aspect, in which the body 100 is double cut, while FIG. 8 depicts an aspect in which the body is single cut. Thus, three-dimensional guitar connection joint can be implemented in a variety of guitar body shapes and models.

It should also be noted that the present disclosure also comprises a guitar having the connection joint as described herein. The guitar includes any other components that are required and known to those skilled in the art to form a complete guitar setup, including strings or chords, electrical wires or components, tuners, or any other components as may be necessary given the desired setup.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A three-dimensional guitar connection joint, comprising:
a guitar body having a shaped neck receptor for receiving a guitar neck; and
a guitar neck having a first end with a stepped connector and an elongated portion extending from the stepped connector to a distal end, the stepped connector being formed to nest within the shaped neck receptor.

2. The three-dimensional guitar connection joint as set forth in claim 1, wherein the elongated portion has a bottom surface, with the stepped connector projecting below the bottom surface.

3. The three-dimensional guitar connection joint as set forth in claim 2, further comprising a neck passage formed in the body adjacent to the shaped neck receptor that passes from the neck receptor to an exterior of the body, the neck passage formed to receive the elongated portion of the guitar neck.

4. The three-dimensional guitar connection joint as set forth in claim 3, wherein the stepped connected includes a step shaped aperture.

5. The three-dimensional guitar connection joint as set forth in claim 4, wherein the body includes a pair of voids of that are adjacent to and straddle opposing sides of the neck receptor.

6. The three-dimensional guitar connection joint as set forth in claim 5, wherein the pair of voids and step shaped aperture collectively form a pocket across the top of the neck to allow for placement of a guitar pickup.

7. The three-dimensional guitar connection joint as set forth in claim 6, wherein a fastener setup secures the neck into neck receptor.

8. The three-dimensional guitar connection joint as set forth in claim 7, wherein the fastener setup includes a bracket positioned on a bottom-side of the body and two anchors embedded into the neck, with fasteners passing through the bracket and being secured into the two anchors to secure the neck to the body.

9. The three-dimensional guitar connection joint as set forth in claim 8, further comprising a guitar pickup positioned in the pocket.

10. The three-dimensional guitar connection joint as set forth in claim 1, wherein the stepped connected includes a step shaped aperture and the body includes a pair of voids of that are adjacent to and straddle opposing sides of the neck receptor, such that the pair of voids and step shaped aperture collectively form a pocket across the top of the neck to allow for placement of a guitar pickup.

11. The three-dimensional guitar connection joint as set forth in claim 10, further comprising a guitar pickup positioned in the pocket.

12. The three-dimensional guitar connection joint as set forth in claim 1, further comprising a neck passage formed in the body adjacent to the shaped neck receptor that passes from the neck receptor to an exterior of the body, the neck passage formed to receive the elongated portion of the guitar neck.

13. The three-dimensional guitar connection joint as set forth in claim 1, wherein the stepped connected includes a step shaped aperture.

14. The three-dimensional guitar connection joint as set forth in claim 1, wherein the body includes a pair of voids of that are adjacent to and straddle opposing sides of the neck receptor.

15. The three-dimensional guitar connection joint as set forth in claim 1, wherein a fastener setup secures the neck into neck receptor, the fastener setup including a bracket positioned on a bottom-side of the body and two anchors embedded into the neck, with fasteners passing through the bracket and being secured into the two anchors to secure the neck to the body.

16. The three-dimensional guitar connection joint as set forth in claim 1, wherein the stepped connected includes a step shaped aperture and the body includes a pair of voids of that are adjacent to and straddle opposing sides of the neck receptor, such that the pair of voids and step shaped aperture collectively form a pocket across the top of the neck to allow for placement of a guitar pickup.
